(19) United States
(12) Patent Application Publication
(10) Pub. No.: US 2017/0046751 A1
(43) Pub. Date: Feb. 16, 2017

(54) INFORMATION RESOURCE IDENTIFICATION FOR CONTENT ITEM PLACEMENT CAMPAIGNS IN A COMPUTER NETWORK ENVIRONMENT

(71) Applicant: Google Inc., Mountain View, CA (US)

(72) Inventors: Roman Kirillov, London (GB); Daniel Banfield, London (GB)

(73) Assignee: Google Inc., Mountain View, CA (US)

(21) Appl. No.: 14/181,198

(22) Filed: Feb. 14, 2014

(51) Int. Cl. G06Q 30/02

(52) U.S. Cl. CPC G06Q 30/0277

(57) ABSTRACT

Systems and methods of identifying information resources for content item placement campaigns are provided. A data processing system can identify a request from a content provider computing device via a computer network to initiate a direct content item placement campaign. The request can indicate an information resource. A content item slot of the information resource can be identified and a rendering of the information resource can be provided for display by the content provider computing device. The rendering can include a preview interface indicating the content item slot. Actuation of the preview interface during display of the information resource at the content provider computing device can be detected, and a content item associated with the content provider computing device can be identified. The content item can be provided for display in the content item slot of the information resource, at the content provider computing device.

### BACKGROUND

In a computer networked environment such as the internet, entities such as people or companies provide information for public display on web pages or other online documents. The documents can include information provided by the entities via a computing device for display on the internet. Content can also be provided by third parties for display on the documents together with the information provided by the entities. Thus, a person viewing a document can access the information that is the subject of the document, as well as third party content that may or may not be related to the subject matter of the document.

### SUMMARY

At least one aspect is directed to a computer implemented method of identifying information resources for content item placement campaigns. The method can include obtaining, by a data processing system, a request from a content provider computing device via a computer network to initiate a direct content item placement campaign. The request can indicate an information resource. The method can include identifying, by the data processing system and responsive to the request, a content item slot of the information resource, and providing a rendering of the information resource for display by the content provider computing device. The rendering can include a preview interface indicating the content item slot. The method can include detecting an actuation of the preview interface during display of the information resource at the content provider computing device, and replacing, responsive to the actuation of the preview interface, at least part of the preview interface with a placeholder icon displayed in the content item slot of the information resource. The method can include identifying, responsive to at least one of the request and the actuation of the preview interface, a content item associated with the content provider computing device, and providing, based on the actuation of the preview interface and in place of the placeholder icon, the content item for display in the content item slot of the information resource, at the content provider computing device.

At least one aspect is directed to a system of identifying information resources for content item placement campaigns. The system can include a data processing system that can identify, via a computer network, a request from a content provider computing device to initiate a direct content item placement campaign. The request can indicate an information resource. The system can identify, responsive to the request, a content item slot of the information resource, and can provide a rendering of the information resource for display by the content provider computing device. The rendering can include a preview interface indicating the content item slot. The system can detect an actuation of the preview interface during display of the information resource at the content provider computing device, and can identify, responsive to at least one of the request and the actuation of the preview interface, a content item associated with the content provider computing device. The system can provide, based on the actuation of the preview interface, the content item for display in the content item slot of the information resource, at the content provider computing device.

At least one aspect is directed to a computer readable storage device storing instructions that when executed by one or more data processors, cause the one or more data processors to perform operations. The operations can include identifying a request from a content provider computing device via a computer network to initiate a direct content item placement campaign. The request can indicate an information resource. The operations can include identifying, responsive to the request, a content item slot of the information resource, and providing a rendering of the information resource for display by the content provider computing device. The rendering can include a preview interface indicating the content item slot. The operations can include detecting an actuation of the preview interface during display of the information resource at the content provider computing device, and replacing, responsive to the actuation of the preview interface, at least part of the preview interface with a placeholder icon displayed in the content item slot of the information resource. The operations can include identifying, responsive to at least one of the request and the actuation of the preview interface, a content item associated with the content provider computing device, and providing, based on the actuation of the preview interface and in place of the placeholder icon, the content item for display in the content item slot of the information resource, at the content provider computing device.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting one example environment to identify information resources for content item placement campaigns, according to an illustrative implementation;

FIG. 2 is a display depicting one example of an information resource, according to an illustrative implementation;

FIG. 3 is a display depicting one example of an information resource, according to an illustrative implementation;

FIG. 4 is a display depicting one example of an information resource, according to an illustrative implementation;

FIG. 5 is a flow diagram depicting an example method of identifying information resources for content item placement campaigns, according to an illustrative implementation; and

FIG. 6 is a block diagram illustrating a general architecture for a computer system that may be employed to implement elements of the systems and methods described and illustrated herein, according to an illustrative implementation.

### DETAILED DESCRIPTION

Following below are more detailed descriptions of various concepts related to, and implementations of, methods, apparatuses, and systems of providing information via a computer network. The various concepts introduced above and discussed in greater detail below may be implemented in any of numerous ways, as the described concepts are not limited to any particular manner of implementation.

Systems and methods of the present disclosure relate generally to the creation of online direct content item placement campaigns via a computer network, where a content provider can preview their content items displayed with information resources of content publishers, prior to initiation of the campaign. For example, a content provider such as an advertiser may decide to provide content items such as advertisements for display in content item slots of information resources such as web pages. To set up or create this content item placement campaign, the content provider, using a content provider computing device, can select a web page for inclusion of content items (e.g., ads) associated with the content provider.

A content item placement server or other data processing system can identify the selection of the web page for inclusion of content items as a request to initiate a content item placement campaign. For example, the selected web page can include an link, button, or other interface that when actuated (e.g., clicked) provides a communication to the data processing system via the computer network indicating a request to initiate a content item placement campaign associated with the content provider computing device. Responsive to the request, for example, the data processing system can identify content item slots (e.g., ad slots) of the web page or other information resource, and can render the web page at the content provider computing device together with at least one preview interface that identifies at least one content item slot of the web page.

In this rendering, content item slots of the web page can be highlighted or otherwise identified by preview interfaces as areas where content items associated with the content item provider may appear. The preview interfaces identifying content item slots of the rendered web page can include buttons, links, or other interfaces that can be clicked or otherwise actuated. The data processing system, which may include a script thereof executing at the content provider computing device, can identify this actuation and provide content items associated with the content provider computing device for display in the content item slots of the web page, in place of the preview interfaces or in place of any previous or original content items. The content items can be displayed in the content item slots in lieu of the preview interface, for example, during the same or a subsequent rendering of the web page at the content provider computing device. In some examples, the preview interface can be replaced by a placeholder icon during selection or preparation of the content item for display in the content item slot, and the placeholder icon can be replaced by the content item, in the content item slot, for display with the web page or other information resource.

The data processing system that may generate or initiate the content item placement campaign can provide a script for installation at the content provider computing device. The script can execute at the content provider computing device to render the information resource with preview interfaces that highlight or indicate the content item slots. Responsive to actuation of the preview interfaces, the content provider computing device can execute the script at least in part to display content items in the content item slots.

The content provider (e.g., user) of the content provider computing device can view the web page or other information resource as it would appear with ads or other content items of the content provider included in the content item slots of the web page. Should the content provider be satisfied with the appearance of the web page in this preview, the content provider computing device can instruct the data processing system to create or implement a content item placement campaign where content items of the content provider are provided in content item slots of the web page during renderings of the web page at end user computing devices. The data processing system can provide, among other things, content providers with direct and real time previews of their content items displayed in specified content item slots with information resources of content publishers, as those information resources currently appear on a computer network such as the internet, prior to or to initiate implementation of a direct online content item placement campaign.

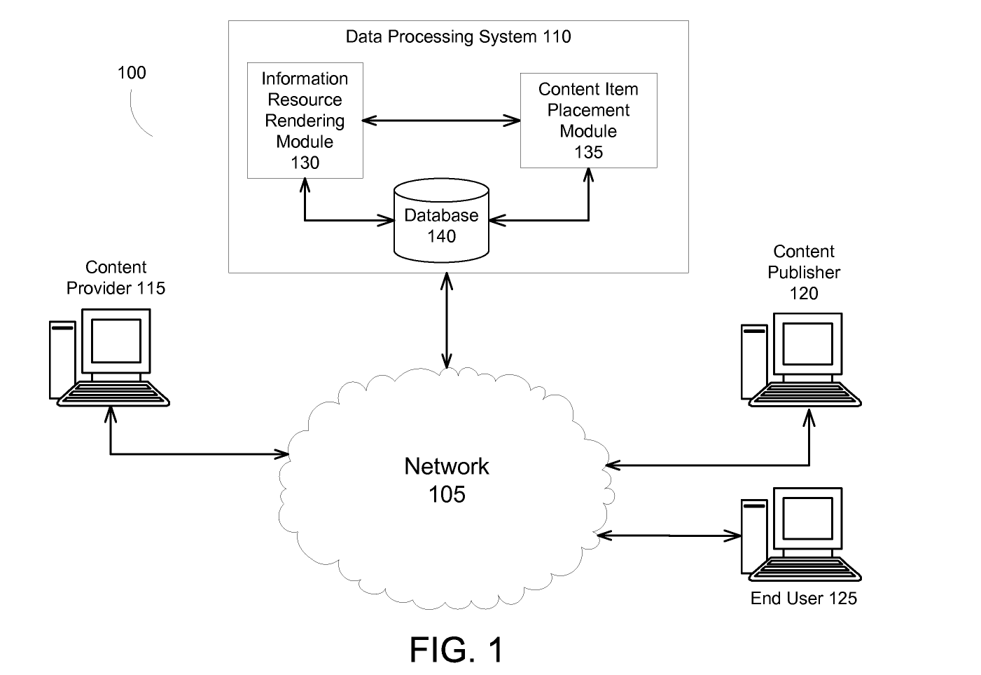

FIG. 1 illustrates an example system 100 for identifying information resources for a content item placement campaign via at least one computer network, such as the network 105. The network 105 can include computer networks such as the internet, local, wide, metro or other area networks, intranets, satellite networks, other computer networks such as voice or data mobile phone communication networks, and combinations thereof. The system 100 can also include at least one data processing system 110, e.g., at least one logic device such as a computing device or server having at least one processor to communicate via the network 105, for example with at least one content provider computing device 115, at least one content publisher computing device 120, or at least one end user computing device 125.

The data processing system 110 can include at least one server. For example, the data processing system 110 can include a plurality of servers located in at least one data center or server farm. In one implementation, the data processing system 110 includes a content placement system, e.g., an ad server or ad placement system. The data processing system 110 can include at least one information resource rendering module 130, at least one content item placement module 135, and at least one database 140. The information resource rendering module 130 and the content item placement module 135 can each include at least one processing unit, server, virtual server, circuit, engine, agent, appliance, or other logic device such as programmable logic arrays configured to communicate with the database 140 and with other computing devices (e.g., the content provider computing device 115, the content publisher computing device 120, or the end user computing device 125) via the network 105.

The information resource rendering module 130 and the content item placement module 135 can include or execute at least one computer program or at least one script. The information resource rendering module 130 and the content item placement module 135 can be separate components, a single component, or part of the data processing system 110. The information resource rendering module 130 and the content item placement module 135 can include combinations of software and hardware, such as one or more processors configured to execute one or more scripts to obtain requests to initiate a content item placement campaign, identify content item slots (e.g., ad slots or ad units) of information resources, provide a rendering of the information resource at the content provider computing device, detect an actuation of a preview interface of the information resource during display of the information resource at the content provider device 115, replace or overlay a placeholder icon over the preview interface, identify a content item, or provide the content item in the content item slot for display at the content provider computing device 115, for example.

The content provider computing devices 115 can include servers or other computing devices operated by a content provider entity to provide content items such as advertisements for display on information resources at the end user computing device 125. The content provided by the content provider computing device 115 can include third party content items (e.g., ads) for display on information resources such as a website or web page that includes primary content, e.g. content provided by the content publisher computing device 120. The content items can also be displayed on a search results web page. For example, the content provider computing device 115 can provide or be the source of ads or other content items for display in content slots of content web pages such as a web page of a company where the primary content of the web page is provided by the company, or for display on a search results landing page provided by a search engine. The content items associated with the content provider computing device 115 can be displayed on information resources other than web pages, such as content displayed as part of the execution of an application on a smartphone or other end user computing device 125.

The content publisher computing devices 120 can include servers or other computing devices operated by a content publishing entity to provide primary content for display via the network 105. For example, the content publisher computing device 120 can include a web page operator who provides primary content for display on the web page or other information resource. In addition to the primary content, the information resource can include content other than that provided by the content publisher computing device 120, and the web page can include content slots configured for the display of third party content items (e.g., ads) from the content provider computing devices 115. For example, the content publisher computing device 120 can operate the website of a company and can provide content about that company for display on web pages of the website. The web pages can include content item slots configured for the display of third party content items such as ads of the content provider computing device 115. In some implementations, the content publisher computing device 120 includes a search engine computing device (e.g. server) of a search engine operator that operates a search engine website. The primary content of search engine web pages (e.g., a results or landing web page) can include results of a search as well as third party content items displayed in content item slots such as content items from the content provider computing device 115.

The end user computing devices 125 can include computing devices configured to communicate via the network 105 to display data such as the content provided by the content publisher computing device 120 (e.g., primary web page content or other information resources) and the content provided by the content provider computing device 115 (e.g., third party content items such as ads configured for display in a content slot of a web page). The end user computing device 125, the content provider computing device 115, and the content publisher computing device 120 can include desktop computers, laptop computers, tablet computers, smartphones, personal digital assistants, mobile devices, end user computing devices, consumer computing devices, servers, clients, and other computing devices. The end user computing device 125, the content provider computing device 115, and the content publisher computing device 120 can include user interfaces such as graphical user interfaces, microphones, speakers, touchscreens, keyboards, pointing devices, a computer mouse, touchpad, or other input or output interfaces.

The data processing system 110 can include the information resource rendering module 130 and the content item placement module 135 as part of one or more servers of an online content item placement campaign system to identify information resources of the content publisher computing device 120, render the information resources at the content provider computing device 115 as part of the creation of a content item placement campaign, and provide content items of the content provider computing device 115 for display in content item slots of the information resource rendered at the content provider computing device 115. This can occur, for example, as a preview so the content provider associated with the content provider computing device 115 can see what the content provider's content items would look like if they were displayed with the information resource at the end user computing devices 125. A content provider satisfied with this preview can communicate via the content provider computing device 115 and the network 105 with the data processing system 110 to create or implement a direct content item placement campaign that places the content items with the information resource for display by the end user computing device 125.

The information resource rendering module 130 can be part of, or can include scripts executed by, one or more servers in a content placement system configured to identify an information resource of the content publisher computing device 120 and provide the same for rendering at the content provider computing device 115. The content item placement module 135 can be part of the same or a different server as the information resource rendering module 130 in the data processing system 110, e.g., a system that is part of or can provide data to a content placement system. The content item placement module 135 can provide content items of the content provider computing device 115 for display, e.g., as a preview, with the rendering of the information resource to depict what the information resource would look like if it were to include those content items as part of an online content item placement campaign.

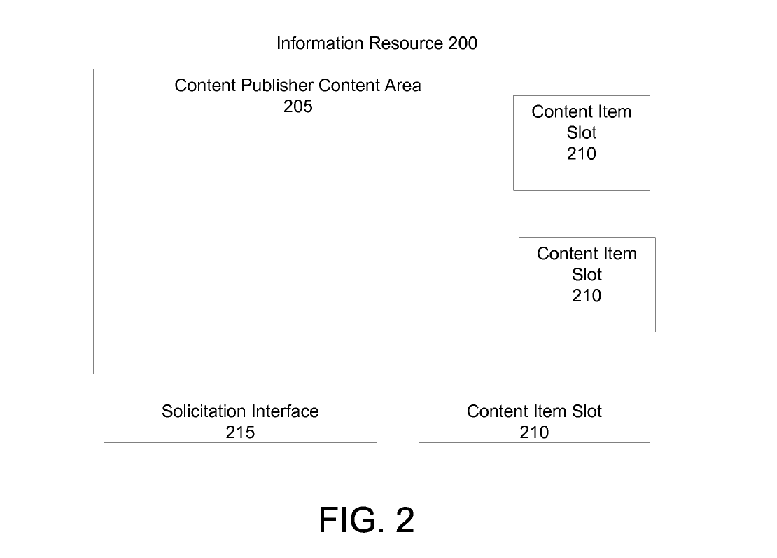

FIG. 2 depicts an example information resource 200 such as a web page or other online document. The information resource 200 can be associated with or hosted by the content publisher computing device 120 and displayed by the content provider computing device 115 or by the end user computing device 125. For example, the content publisher computing device 120 can include a web server that hosts the information resource 200 (e.g., a web page). The information resource 200 can include first party content in at least one content publisher content area 205. Subject matter created by or associated with the host (or content publisher) of the web page can be displayed in the content area 205. For example, the information resource 200 may be a shoe fashion blog hosted by the content publisher computing device 120. A content provider (e.g., the person who created the shoe blog) can provide blog entries or other information about shoes for display as content in the content publisher content area 205.

The information resource 200 can also include at least one content item slot 210. The content item slots 210 can include areas of the information resource 200 configured for display of third party content, such as content items associated with the content provider computing device 115. The information resource 200 can also include at least one solicitation interface 215. The solicitation interface 215 can solicit offers for third party content providers to advertise on the information resource 200. For example, the solicitation interface 215 can include a display to the effect of “advertise here” or “your ad here” to alert content providers of the opportunity to provide their content items for display in the content item slots 210 of the information resource 200.

The solicitation interface 215 can include a button, link or other interface that, when actuated by a click or other input into the content provider computing device 115 where the information resource 200 is displayed causes transmission of a communication via the network 105 to the data processing system 110. This communication can indicate a request from the content provider computing device 115 to initiate a direct content item placement campaign to provide associated content items for display in one or more content item slots 210 of the information resource 200, or a request to preview what content items associated with the content provider computing device 115 look like when displayed in the content item slots 210 of that information resource 200. Thus, the content provider computing device 115 can browse information resources 200 (e.g., hosted by the content publisher computing devices 120) available via the network 105 and can select specific information resources 200 as candidates for a direct content item placement campaign. This rendering or impression of the information resource 200 at the content provider computing device 115 can include content items such as ads displayed in the content item slots 210. These ads may include existing ads displayed with the information resource 200 that are not associated with the content provider computing device 115.

The layout, look, feel, or configuration of the information resources 200 can vary, and the information resource can include web pages, application displays, or other online documents configured for display on various end user computing devices 125 such as desktop computers, smartphones, or tablet computers. The information resource 200, content publisher content areas 205, content item slots 210, and solicitation interfaces 215 need not have the number, shape, layout or configuration as in FIG. 2. For example, the content item slots 210 can appear within the content publisher content area 205, or in the top, bottom, or side margins of the information resource 200, and the content item slots 210 need not be square or quadrilateral.

In some implementations, the information resource 200 is a web page or other online document made available by the content publisher computing device 120 for public access and viewing by the end user computing devices 125. For example, the information resource 200 can be a publically available web page at a point in time. The content provider computing device 115, e.g., operating as an end user computing device 125, can access and view the information resource 200, displayed for example by a web browser of the content provider computing device 115. The content displayed with the information resource 200 can include first party content (e.g., of the content published and displayed in the content area 205), as well as third party content items displayed the content item slots 210 as part of previous or existing content item placement campaigns.

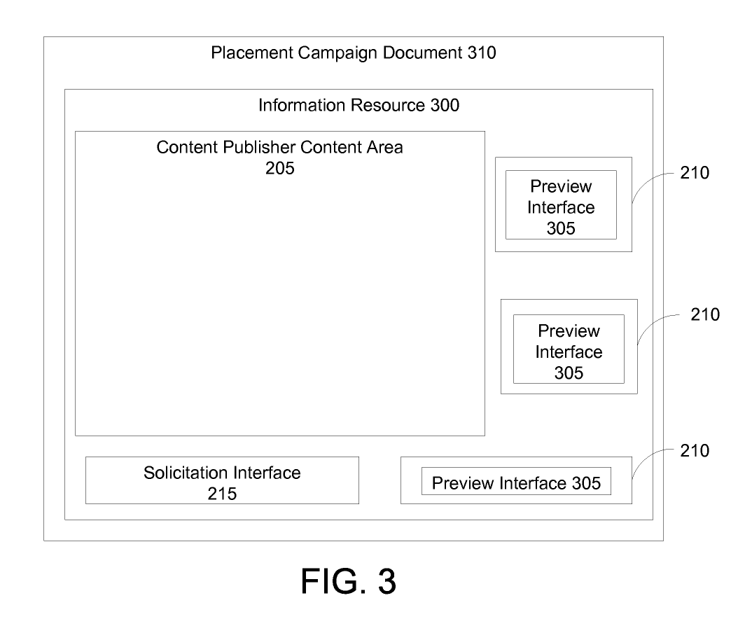

FIG. 3 depicts an example information resource 300 that can be rendered for display by the content provider computing device 115 during creation of a direct content item placement campaign. For example, the data processing system 110 can receive, via the network 105, an indication that the content provider computing device 115 has actuated the solicitation interface 215 of the information resource 200 (e.g., of FIG. 2) during display of the information resource 200 by the content provider computing device 115. Responsive to this request to initiate a content item placement campaign, the data processing system 110 (e.g., one or more servers that creates or initiates online content item placement campaigns) or a component thereof such as the information resource rendering module 130 can identify the information resource 200 displayed by the content provider computing device 115 or associated with the actuation of the solicitation interface 215. From the identified information resource 200, the data processing system 110 can create a rendering of the information resource 300 (e.g., of FIG. 3) for display by the content provider computing device 115. In some implementations, rather than identifying the information resource 200 responsive to actuation of the solicitation interface 215, the data processing system 110 instead identifies or selects the information resource 200 based on the content of content items associated with the content provider computing device 115.

The information resource 300 provided for rendering at the content provider computing device 115, as in the example of FIG. 3, can be a replica, copy, simulation, or re-rending of the information resource 200, as in the example if FIG. 2, and the data processing system 110 can overlay at least one preview interface 305 over the content item slots 210, as in FIG. 3. Content item slots 210 associated with preview interfaces 305 can be available for placement of content items associated with the content provider computing device 115 as part of a direct content item placement campaign for the information resource 200. The data processing system 110 can identify the content item slots 210 of the information resource 200, for example based on information about or characteristics of the information resource 200 received from the content publisher computing device 120 or based on an evaluation of the information resource by the data processing system 110. The data processing system 110 can determine the shape, size, type, or location of the content item slots 210 of the information resource 200.

In some implementations, the information resource 300 includes a rendering of the information resource 200 with at least one preview interface 305 overlaying at least one content item slot 210. The preview interface 305 need not be a direct overlay of the content item slot 210. For example, the preview interface 305 can be located anywhere on the information resource 300 and can be associated with at least one content item slot 210, for example via pointers or a display within the preview interface 305 associating it with an identified content item slot 210.

The content provider associated with the content provider computing device 115 can see what their content items look like if they were to be provided for display with the information resource 200 in the content item slots 210 that currently may be occupied by other content items such as ads associated with a different content provider. To do so, the content provider computing device 115 can actuate, responsive to user input, the solicitation interfaces 215 from the rendering of the information resource 200, causing the data processing system 110 to render the information resource 300.

The renderings of the information resource 200 and the information resource 300 by the content provider computing device 115 can be different renderings. For example, the information resource 200 can be rendered responsive to a request from the content provider computing device 115 to the content publisher computing device 120 to access the information resource 200. The information resource 300 can be rendered responsive to a request from the content provider computing device 115 to the data processing system 110 to initiate a direct content item placement campaign to place content items associated with the content provider computing device 115 in the content item slots 210 of the information resource, as a substitute or replacement for whatever content items may already be present in the content item slots 210.

In one implementation, the information resource 300 is provided by the data processing system 110 for display by the content provider computing device 115 within another information resource, such as the placement campaign document 310. The placement campaign document 310, for example, can be a web page of the data processing system 110 that is used to create online content item placement campaigns. The information resource 300 can be presented as a static or non-functioning document (e.g., a screenshot) with non-functioning links or features, or as a dynamic document with operating links and other features that operate the same as those of the information resource 200.

To render the information resource 300, the data processing system 110, for example using a screen capture tool, can generate an image and display it in the placement campaign document 310. This image may be a static image. The data processing system 110 can also place or embed an iframe or inline frame element in the placement campaign document 310 and then load the information resource 200 using the iframe to create the information resource 300 as a dynamic, functional information resource. Both static and dynamic renderings of the information resource 300 can include the information resource 200 loaded on the content provider computing device 115 with the preview interface 305 overlaying the content item slots 210 to indicate the location of the content item slots 210 on the information resource 200, and to indicate that the content item slots 210 are available for purchase or insertion of content items associated with the content provider computing device 115. In some implementations, the information resource 300 is created from a cached version of the information resource 200, stored for example in the database 140.

The preview interface 305 can indicate that the content item slots 210 are available for booking—e.g., available for placement of content items associated with the content provider computing device 115 as part of a direct placement ad campaign. For example, the preview interface 305 can include a button, link, or graphic with the word “book” or “your ad here” or other indicators to that effect. In some implementations, the preview interface 305 displays information about the content item slot 210, such as its shape (e.g., square), size (e.g., pixel by pixel dimensions) or location (e.g., in the leaderboard or banner area generally along the top of web pages or other information resources). For example, the preview interface 305 can identify the content item slots 210 as a square advertiser creative, mobile advertiser creative, or a leaderboard advertiser creative. The data processing system 110 or component thereof such as the information resource rendering module 130 can identify the content item slots 210 of the information resource and provide the information resource 300 for rendering at the content provider computing device 115 with at least one preview interface 305 that overlays or otherwise identifies or indicates at least one content item slot 210.

The preview interface 305 can be opaque, translucent, or transparent, and can block, all, some, or none of any content item displayed in the content item slots 210. For example, the preview interface 305 can include an overlay displaying the word “book” or “purchase this space”, or other indicator of the availability of the content item slot 210, with at least a portion of a content item visible in the content item slot 210. In one implementation, the preview interface 305 is a gray-scale overlay that partially obscures the content item displayed in the content item slot 210.

The content provider computing device 115 can actuate the preview interface 305. For example, a user of the content provider computing device 115 can click, scroll, or drag-and-drop a content item over the preview interface 305 to generate a communication that is transmitted to the data processing system 110 via the network 105. The data processing system 110 can receive this communication and interpret it as a command to provide a preview of a content item associated with the content provider computing device 115 for display in at least one content slot 210 that, for example, may also be identified in the communication. The data processing system 110 or a component thereof such as the content item placement module 135 can then provide an ad or other content item for display in the content item slot 210 of the information resource 300 at the content provider computing device 115.

In one implementation, a user of the content provider computing device 115 can hover a mouse pointer over the preview interface 305. This can transform the preview interface 305 into a drop zone. For example, the data processing system 110 including a script executing at the content provider computing device 115 can provide a tooltip display instructing the user how to upload one or more content items for display in the content item slots 210, for example by dragging and dropping the content item into the preview interface 305 or into the content item slot 210. In this example, the user knows which content item slot 210 will display the content item, and where that content item slot 210 is located on the information resource 300, which can correspond to the location of the content item slot 210 on the information resource 200. Once the user drops the content item into the preview interface 305 or content item slot 210, a placeholder icon can appear as an overlay of the content item slot 210 or other part of the information resource 300. The placeholder icon can indicate that the dropped content item is being formatted or retrieved for placement in the content item slot 210.

In some implementations, the data processing system 110 identifies actuation of the preview interface 305. This actuation can instruct the data processing system 110 or component thereof such as the content item placement module 135 to provide a content item for placement in the content item slot 210 associated with the actuated preview interface 305. During the time period when the data processing system 110 identifies a content item associated with the content provider 115, the data processing system 110, which may include a script executing at the content provider computing device 115, can replace or supplement the preview interface with at least one placeholder icon.

For example, the placeholder icon can include an hourglass image, thumbnail image of the content item to be previewed in the content item slot 210, or a spinning or rotating icon that indicates processing activity of the content provider computing device 115. The placeholder icon can overlay the preview interface 305 or the content item slot 210. The placeholder icon can also replace a mouse pointer icon on the display of the information resource 300. During this time, the data processing system 110 can retrieve the content item (e.g., from the database 140 or from a database of the content provider computing device 115. Subsequent display of the selected content item in the content item slot 210 can remove the placeholder icon from the display of the information resource 300 or replace it with at least one content item.

The content item slots 210 can be responsive content item slots configured for information resources that automatically adapt for rendering on different screen sizes of different end user computing devices 125. The size of the responsive content item slot can adapt to the size or layout of the information resource. In some implementations, the data processing system 110 identifies the content item slot 210 as a responsive content item slot. The data processing system 110 can configure the responsive content item slot for display with the information resource 300 based on a screen size of a mobile computing device or other end user computing device 125. To identify the content item slots 210 of the information resource 200 or 300, for example, the data processing system 110 can produce a document object model of the information resource 200 or 300 and can identify coordinates of images of the information resource. For example, the data processing system 110, which may include a script executing at the content provider computing device 115, can identify coordinates such as a top-left corner (or other area) or size (width-height) coordinates of an image, and can evaluate the document object model of the information resource 200 or 300 using these coordinates to identify the content item slots 210.

The data processing system 110 can provide the rendering of the information resource 300 at the content provider computing device 115 with the responsive content item slot and the information resource 300 configured for display by a mobile computing device or other end user computing device 125, based on the screen size of the end user computing device 125 (e.g., the mobile computing device) and not the screen size of the content provider computing device 115 (e.g., a desktop computing device). In this example the content provider (e.g., advertiser or user) of the content provider computing device 115 can preview what the content items would look like on end user computing devices 125 that are different types of devices than the content provider computing device 115. For example, the content provider computing device 115 can include a desktop computer having a 21 inch monitor with a 1680 pixel width (or any other size), and the information resource 300 can be displayed as it would look on an end user computing device 125 such as a tablet computer with a 1024 pixel width (or any other size). For example, the responsive content item slot displayed on a 21 inch monitor of a desktop computer could appear as a 307×250 pixel sized slot suitable for a 1024 pixel width tablet device rather than as a 504×60 pixel sized slot suitable for a 21 inch monitor of a desktop computer. Thus, the content provider can see what the content items 405 look like when displayed on a variety of end user computing devices 125.

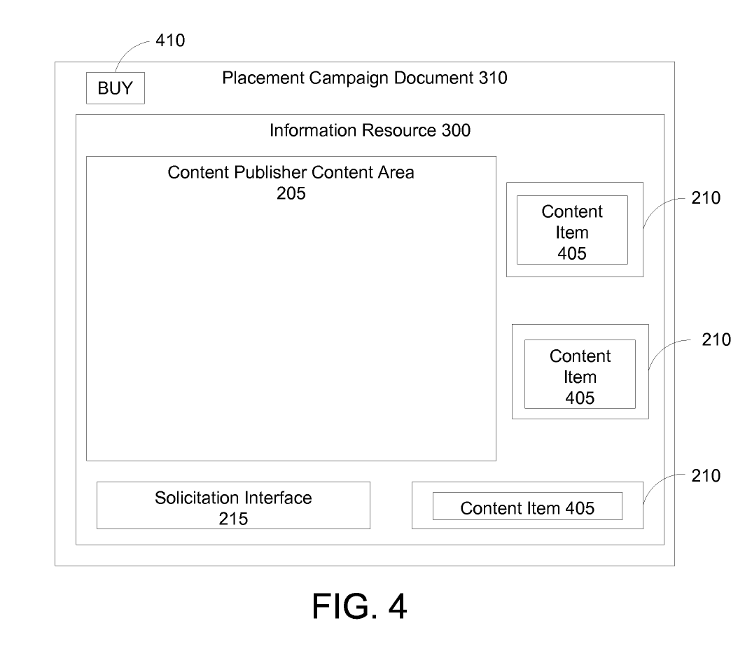

FIG. 4 depicts an example of the information resource 300 rendered for display by the content provider computing device 115 during creation of a direct content item placement campaign. For example, responsive to actuation of the preview interface 305, the data processing system 110 can provide at least one content item 405 for display in the content item slots 210 of the information resource 300. The display of the content item 405 can replace the placeholder icon. The content item 405 can include advertisements, creatives, or other content of the content provider associated with the content provider computing device 115.

In some implementations, one preview interface 305 is associated with more than one content item slot 210, or actuation of one preview interface 305 can cause the data processing system 110 to provide the content items 405 for display in more than one (e.g., all) content item slots 210 of the information resource 300. The data processing system 110 can also detect actuation of a preview interface 305 indicating a selection of one of a plurality of content item slots 210, and in response can provide the content item 405 for display in that one content item slot 210 and not in any additional content item slots 210 of the information resource 300, for example.

The display (e.g., an overlay) of the content items 405 in the content item slots 210 of the information resource 300 can constitute a preview, displayed by the content provider computing device 115, of what the information resource 200 would look like, should the content provider computing device 115 provide an instruction to proceed with the placement campaign. For example, the data processing system 110 or component thereof such as the content item placement module 135 can identify original content in the content item slots 210 of the information resource 200. The data processing system 110 can replace original content items displayed with the information resource 200 during renderings of the information resource 200 by the end user computing devices 125, or by the content provider computing device 115 (e.g., as in FIG. 2), with the content items 405, (e.g., as in FIG. 4) for display as a preview by the content provider computing device 115.

A content provider associated with the content provider computing device 115 satisfied with the preview can input a command to proceed with the online content item placement campaign, e.g., to purchase the content item slots 210 for display of the content items 405 with renderings of the information resource 300 (or 200) at the end user computing devices 125. For example, the content provider computing device 115 can actuate at least one purchase interface 410, such as a button or link. The purchase interface 410 can display an indication to buy or purchase advertising space in the content item slots 210 of the information resource 200. The purchase interface 410 can be part of or independent from the placement campaign document 310. For example, the purchase interface 410 can appear separately from or as an overlay of the information resource 300. In some implementations, clicking the displayed content items 405 operates as the purchase interface 410.

The data processing system 110 can receive an indication from the content provider computing device 115 that the purchase interface 410 was actuated, and interpret this actuation as authorization to provide the content items 405 for display in the ad slots 210 of the information resource 205 during renderings of the information resource 200 by the end user computing devices 125. Responsive to receiving an indication of the actuation of the purchase interface 410, the data processing system 110 can complete or implement the content item placement campaign by providing additional information (e.g., terms of the campaign) for display by the content provider computing device 115.

Responsive to actuation of the purchase interface 410 or other interface or link of the information resource 300 or the placement campaign document, the data processing system 110 can determine that the content provider computing device 115 requests additional information about the information resource 200. For example, the content provider may be interested in a number of page views, the size of the content item slots 210, the cost to provide content items 405 for display in the content item slots 210, general topical information about the information resource 200, or generic information about typical viewers or the type of audience that the content publisher computing device would like to attract. Responsive to such a request, the data processing system can retrieve this information, e.g., from the database 140 or from the content publisher computing device 120, and can provide it to the content provider computing device 115.

In some implementations, an advertiser or other content provider may intend to advertise via the network 105 by providing ads or other content items for display with information resources of an identified content publisher as part of a direct content item placement campaign. For example, a shoe manufacturer may intend to provide advertisements for their shoes for display on a shoe-related blog. The content provider computing device 115 (e.g., associated with the shoe manufacturer) can communicate with the content publisher computing device 120 (e.g., associated with the shoe blog) to view a web page of the shoe blog at the content provider computing device 115. For example, a web browser of the content provider computing device 115 can retrieve and present the web page for display by the content provider computing device 115. This web page (e.g., the information resource 200) can be the same web page that would be displayed to the end user computing devices 125 that make a similar request for content to the content publisher computing device 120.

With the rendering of the shoe blog web page at the content provider computing device 115, the content provider computing device 115 can actuate the solicitation interface 215 to begin the process of creating an direct content item placement campaign to place content items 405 of the content provider computing device 115 in the content item slots 210 of the shoe blog web page (e.g., the information resource 200). The data processing system 110 can obtain an indication of this actuation, and in response can re-render the shoe blog web page (e.g., information resource 300) at the content provider computing device 115, with the content item slots 210 overlaid, marked or otherwise indicated by the preview interfaces 305. This rendering of the shoe blog web page, for example, is an example of the information resource 300. Thus, the content provider computing device 115 identifies the content item slots 210 that are available to the content provider associated with the content provider computing device 115.

The content provider computing device 115 can actuate at least one preview interface 305. The data processing system 110 can receive an indication of this actuation and in response can provide at least one content item 405 for display in at least one content item slot 210. For example, the content item 405 can include an ad to purchase shoes from the content provider associated with the content provider computing device 115. This constitutes a preview of what the shoe blog web page would look like if it were to display the content items 405 with renderings of the show blog at the end user computing devices 125, for example during internet browsing sessions. In some implementations, the data processing system 110 provides a placeholder icon for display with the information resource 300, responsive to actuation of the preview interface 305, while the data processing system 110 obtains or formats the content item 405 for display with the information resource 300 at the content provider computing device 115.

A content provider satisfied with this preview can, for example, actuate the purchase interface 410 of the placement campaign document 310. The data processing system 110 can receive an indication of this actuation and can provide further information to the content provider computing device 115 to complete or implement the targeted content item placement campaign whereby the content items 405 are provided for display with the information resource 200, in the content item slots 210, by the end user computing devices 125. For example, the shoe manufacturer (the content provider associated with the content provider computing device 115) can provide shoe ads (content items 405) for display with the shoe blog (information resource 200) at the end user computing devices 125. The content items 405 can be provided for display as part of a direct content item placement campaign, e.g., administered by the data processing system 110.

In some implementations the content provider (e.g., user) of the content provider computing device 115 is provided with options to preview multiple web pages or other information resources associated with at least one content publisher computing device 120. For example, the data processing system 110 can provide (e.g., sequentially) multiple information resources 300 for display by the content provider computing device 115, corresponding to multiple information resources 200, modified for example to include preview interfaces 305 to identify the content item slots 210. The multiple information resources can be related, such as different web pages of one website.

For example, the data processing system 110 can provide a rendering of the information resource 300, including content item slots 210, for display by the content provider computing device 115, with the content items 405 displayed in the content item slots 210. The information resource 300 can also include a link or other button or interface that when actuated (e.g., clicked by the content provider computing device 115) can cause the data processing system 110 to provide a rendering of a second information resource 300, including second content item slots 210, for display by the content provider computing device 115 with the content items 405 displayed in the content item slots 210. In this example, the first and second renderings of information resources 300 can be first and second web pages of one website or associated with the same content published computing device 120.

In some implementations, responsive to actuation of the link, the data processing system 110 can communicate via the network 105 with the content publisher computing device 120 to retrieve a second information resource 200 and render it as a second information resource 300 at the content provider computing device 115. In one implementation, the second information resource 300 corresponds to the first information resource 300 but is configured for display on a different type of end user computing device 125.

For example, the first information resource 300 may be configured for display on an end user computing device 125 that is a desktop computer, and the second information resource 300 may be a rendering of the same or a different information resource, but configured for display on an end user computing device 125 that is a mobile device such as a smartphone, mobile phone, or tablet computing device. In these examples, the content provider associated with the content provider computing device 125 can preview the content items 405 in content items slots 210 of web pages or other information resources configured for display on different types of devices. In some implementations, the data processing system 110 or component thereof such as the content item placement module 135 can determine that different content items slots of one information resource 300, or that the content item slots 210 of different (e.g., the first and second) information resources 300 have different dimensions. Responsive to such a determination, the data processing system 110 can size the content items 405 for display in the different content item slots 210. In some implementations, the data processing system 110 sizes or resizes the information resource 300 to indicate what the information resource 300 would look like if displayed on a mobile end user computing device 125 such as a smartphone.

The data processing system 110 can provide different content items associated with the content provider computing device 115 for display in different content item slots 210 of the information resource 300. For example, the data processing system can identify first and second content item slots 210 of the information resource 300 and can provide the same or different content items 405 for display in the different content item slots 210. The content items 405 can be retrieved from the database 140 or from databases associated with the content provider computing device 115 and provided for display with the information resources 300.

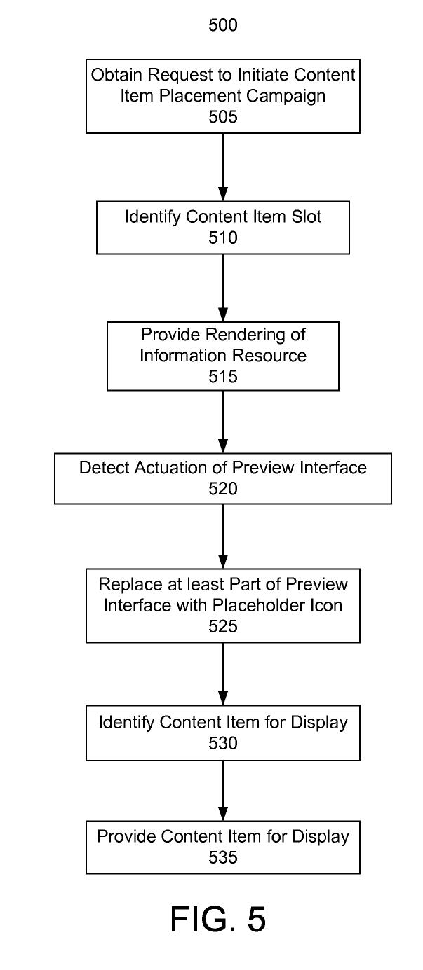

FIG. 5 is a flow diagram depicting an example method 500 of identifying information resources for content item placement campaigns. The method 500 can obtain a request to initiate content item placement campaigns (ACT 505). For example, the data processing system 110 can obtain, from the content provider computing device 115 and via the computer network 105, a request to initiate a content item placement campaign (ACT 505). The request can be obtained or received by the data processing system (ACT 505) responsive to actuation of at least one solicitation interface 215 of the information resource 200 by the content provider computing device 115.

The method 500 can identify at least one content item slot 210 of the information resource 200 or of the information resource 300 (ACT 510). For example, the data processing system 110 can detect, determine, or identify the size, shape, existence, or location of content items slots 210 on or in the information resource 200 or information resource 300 (ACT 510) based on an analysis of the information resource, information received from the database 140, the content provider computing device 115, or the content publisher computing device 120. The information identifying the content item slot 210 can be received by the data processing system 110 together with the request to initiate the content item placement campaign (ACT 505), or can be received in a separate communication.

The method 500 can provide a rendering of the information resource 300 at the content provider computing device 115 (ACT 515). For example, the data processing system 110 (e.g., a content placement server) can provide the information resource 300 for display, including at least one preview interface 305 associated with at least one content item slot 210. The information resource can be provided for rendering (ACT 515) within the placement campaign document 310 or in the absence of a visible placement campaign document 310. In some implementations, the information resource 300 provided for display at the content provider computing device 115 includes at least some features of the information resource 200, and also includes at least one preview interface 305 associated with at least one content item slot 210.

The method 500 can detect actuation of the preview interface 305 (ACT 520). For example, the data processing system 110 that may include a script executing at the content provider computing device 115 can detect a scroll-over, click, or drag-and-drop (e.g., of the content item 405) actuation of the preview interface 305. Responsive to actuation of the preview interface (ACT 520), the data processing system 110 can replace at least part of the preview interface 305 with at least one placeholder icon (ACT 525), indicating that the data processing system 110 is in the process of identifying or loading a content item 405 for display in the content item slot 210 associated with the actuated preview interface 305. For example, using the data processing system 110, the method 500 can replace the preview interface 305 with a placeholder icon indicating loading of the content item 405 (ACT 525).

The method 500 can identify at least one content item 405 for display with the information resource 300 (ACT 530). For example, the content item placement module 135 can obtain, from the database 140 or from the content provider computing device 115, the content item 405. In some implementations, the content provider computing device 115 identifies, indicates, or provides the content item 405 to the data processing system 110, for example via the network 105.

The method 500 can provide, in the information resource 300, at least one content item 405 for display at the content provider computing device 115 (ACT 535). For example, the data processing system 110 or component thereof can insert the content item 405 into the ad slot 210 of the information resource 300. In some implementations, this display constitutes a preview of what the information resource 200 would look like when populated with at least one content item 405 and displayed by at least one end user computing device 125.

The systems and methods disclosed herein, including the operation of the system 100 and acts of the method 500 can be carried out by one or more scripts executing, for example, with a web browser of the content provider computing device 115. In some implementations, the data processing system 110 can provide, via the network 105, at least one script that can be received and executed by the content provider computing device 115. For example, the script can execute as an application on a tablet computer or smartphone, which are example content provider computing devices 115, or with a web browser of the content provider computing device 115 such as a desktop computer. The script can be executed to identify the content item slots 210 or their characteristics, such as their size, type, or location on the information resource 200 or 300.

In some implementations, a component of the data processing system 110 can provide the script to the content publisher computing device 120 such as a web page server. The content publisher computing device 120 can receive, via the network 105, a request from the content provider computing device 115 to access the information resource 200 associated with the content publisher computing device 120 (e.g., a request to view a web page). Responsive to this request, the content publisher computing device 120 can provide the script to the content provider computing device 115. The script can execute at the content provider computing device 115, e.g., with the web browser, to render the information resource 300, detect actuations of the preview interface 305, display placeholder icons, and select, configure, or provide the content items 405 for display in the content item slots 210 of the information resource 300 at the content provider computing device 115.

The data processing system 110 can provide the script directly (e.g., via the network 105) to the content provider computing device 115, or the data processing system 110 can first provide the script to the content publisher computing device 120, which in turn provides it to the content provider computing device, e.g., responsive to a request to access the information resource 200. The script can be considered part of the data processing system 110 (e.g., a content item campaign system) even though the script can be executed by hardware (e.g., of the content provider computing device 115) that is not hardware that is directly part of the data processing system 110 such as one or more servers in a data center configured to initiate and implement content item placement campaigns.

In a direct content item placement campaign, the content provider associated with the content provider computing device 115 can provide the content items 405 for display with the information resource 200 during renderings of the information resource 200 at any end user computing device 125 regardless of and without considering, for example, any characteristics or affinities of those end user computing devices 125. The data processing system 110 can receive authorization from the content provider computing device 115 to provide the content item 405 for display. For example, the data processing system 110 can receive, via the network 105, a communication (e.g., a command or instructions sent responsive to actuation of the purchase interface 410) from the content provider computing device 115 to provide the content item 405 for display with the information resource 200 at the end user computing devices 125 as part of a direct content item placement campaign using the network 105. In some implementations, responsive to the received authorization, the data processing system 110 provides instructions to the content provider computing device 115 to complete or implement the content item placement campaign.

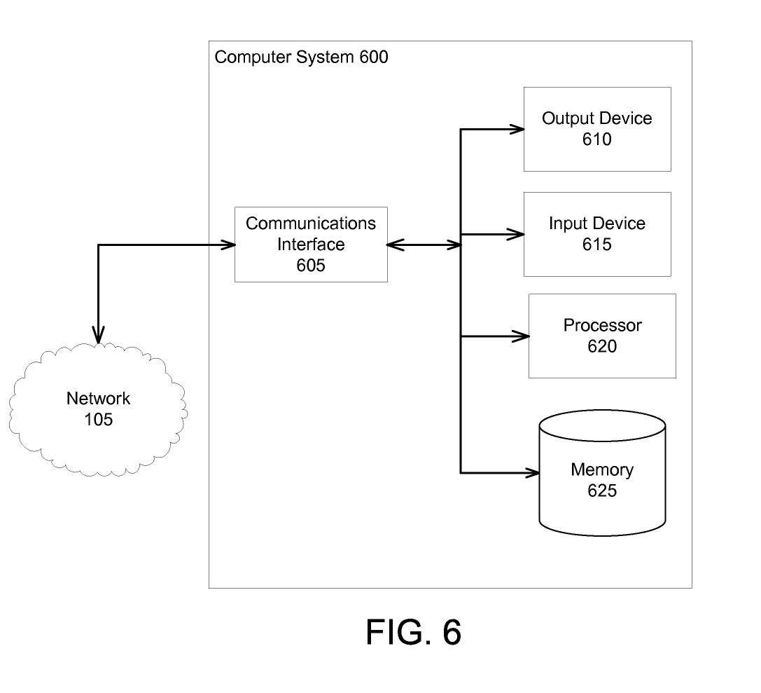

FIG. 6 shows the general architecture of an illustrative computer system 600 that may be employed to implement any of the computer systems discussed herein (including the system 100 and its components such as the data processing system 110, the information resource rendering module 130 or the content item placement module 135) in accordance with some implementations. The computer system 600 can be used to provide information via the network 105, for example to preview content items associated with the content provider computing device 115. The computer system 600 includes one or more processors 620 communicatively coupled to at least one memory 625, one or more communications interfaces 605, and one or more output devices 610 (e.g., one or more display units) and one or more input devices 615. The processors 620 can be included in the data processing system 110 or the other components of the system 100 such as the information resource rendering module 130 or the content item placement module 135.

The memory 625 can include computer-readable storage devices or media, and can store computer instructions such as processor-executable instructions for implementing the operations described herein. The information resource rendering module 130, the content item placement module 135, or the database 140 can include the memory 625 to store content item data, content item slot data, information about information resources, or characteristics of end user computing devices 125, for example. The processor(s) 620 can execute instructions stored in the memory 625 and can read from or write to the memory information processed and or generated pursuant to execution of the instructions.

The processors 620 can be communicatively coupled to or control the communications interface(s) 605 to transmit or receive information pursuant to execution of instructions. For example, the communications interface(s) 605 can be coupled to a wired or wireless network, bus, or other communication means and can allow the computer system 600 to transmit information to or receive information from other devices (e.g., other computer systems). One or more communications interfaces 605 can facilitate information flow between the components of the system 100. In some implementations, the communications interface(s) can be configured (e.g., via hardware components or software components) to provide a website as an access portal to at least some aspects of the computer system 600. Examples of communications interfaces 605 include user interfaces.

The output devices 610 can allow information to be viewed or perceived in connection with execution of the instructions. The input device(s) 615 can allow a user to make manual adjustments, make selections, enter data or other information, or interact in any of a variety of manners with the processor during execution of the instructions.

The subject matter and the operations described herein can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

For situations in which the systems discussed herein collect personal information about users, or may make use of personal information, the users may be provided with an opportunity to control whether programs or features that may collect personal information (e.g., information about a user's social network, social actions or activities, a user's preferences, or a user's location), or to control whether or how to receive content from a content server or other data processing system that may be more relevant to the user. In addition, certain data may be anonymized in one or more ways before it is stored or used, so that personally identifiable information is removed when generating parameters. For example, a user's identity may be anonymized so that no personally identifiable information can be determined for the user, or a user's geographic location may be generalized where location information is obtained (such as to a city, postal code, or state level), so that a particular location of a user cannot be determined. Thus, the user may have control over how information is collected about him or her and used by the content server.

The term “data processing system” or “computing device” “module” “engine” “component” or “computing device” encompasses apparatuses, devices, and machines for processing data, including by way of example a programmable processor, a computer, a system on a chip, or multiple ones, or combinations, of the foregoing. The apparatuses can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination thereof. The apparatus and execution environment can realize various different computing model infrastructures, such as web services, distributed computing and grid computing infrastructures. The information resource rendering module 130 or the content item placement module 135 can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 110) to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

The subject matter described herein can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or a combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 100 or system 600 can include clients and servers. A client and server are generally remote from each other and typically interact through a communication network (e.g., the network 105). The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server (e.g., received by the data processing system 110 from the content provider computing device 115).

While operations are depicted in the drawings in a particular order, such operations are not required to be performed in the particular order shown or in sequential order, and all illustrated operations are not required to be performed. Actions described herein can be performed in a different order.

The separation of various system components does not require separation in all implementations, and the described program components can be included in a single hardware or software product. For example, information resource rendering module 130 or the content item placement module 135 can be a single module, a logic device having one or more processing circuits, script, or part of an online content item placement system e.g., the data processing system 110.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementation,” “an alternate implementation,” “various implementation,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method of identifying information resources for content item placement campaigns, comprising:
obtaining, by a data processing system, a request from a content provider computing device via a computer network to initiate a direct content item placement campaign, the request indicating an information resource;
identifying, by the data processing system and responsive to the request, a content item slot of the information resource;
providing a rendering of the information resource for display by the content provider computing device, the rendering including a preview interface indicating the identified content item slot, the preview interface overlaying at least part of the identified content item slot;
detecting a scroll-over actuation of the preview interface overlaid on the identified content item slot during display of the information resource at the content provider computing device;
replacing, responsive to the scroll-over actuation of the preview interface, at least part of the preview interface with a placeholder icon displayed in the identified content item slot of the information resource;
identifying, responsive to at least one of the request and the scroll-over actuation of the preview interface, a content item associated with the content provider computing device; and
providing, based on the scroll-over actuation of the preview interface, in place of the placeholder icon, the content item for display in the identified content item slot of the information resource at the content provider computing device.

2. The method of claim 1, comprising:
providing a script to the content provider computing device for execution, by the content provider computing device, identify the content item slot of the information resource; and
obtaining, by the data processing system, characteristics of the content item slot of the information resource.

3. The method of claim 2, comprising:
providing the script from the data processing system to a content publisher computing device associated with the information resource, the script configured for downloading from the content publisher computing device to the content provider computing device responsive to a request by the content provider computing device to access the information resource.

4. The method of claim 3, wherein the script is part of the data processing system.

5. The method of claim 1, comprising:
generating a placement campaign document for display at the content provider computing device, the placement campaign document including the rendering of the information resource at the content provider computing device.

6. (canceled)

7. The method of claim 1, comprising:
providing a script for execution at the content provider computing device to provide the rendering of the information resource at the content provider computing device, responsive to a request by the content computing device to access the information resource.

8. The method of claim 1, comprising:
identifying, by the data processing system, a request from the content provider computing device to the content publisher computing device via the computer network to access the information resource;
detecting, by the data processing system, actuation of a solicitation interface associated with the information resource at the content provider computing device;
obtaining the request to initiate the direct content item placement campaign based on the actuation of the solicitation interface.

9. The method of claim 1, comprising:
providing a placement campaign document, the placement campaign document including the rendering of the information resource, for display by the content provider computing device.

10. The method of claim 1, comprising:
providing the rendering of the information resource within a placement campaign document for display by the content provider computing device.

11. A system of identifying information resources for content item placement campaigns, comprising a data processing system configured to:
identify, via a computer network, a request from a content provider computing device to initiate a direct content item placement campaign, the request indicating an information resource;
identify, responsive to the request, a content item slot of the information resource;
provide a rendering of the information resource for display by the content provider computing device, the rendering including a preview interface indicating the identified content item slot, the preview interface overlaying at least part of the identified content item slot;
detect a scroll-over actuation of the preview interface overlaid on the identified content item slot during display of the information resource at the content provider computing device;
identify, responsive to at least one of the request and the scroll-over actuation of the preview interface, a content item associated with the content provider computing device; and
provide, based on the scroll-over actuation of the preview interface, the content item for display in the identified content item slot of the information resource at the content provider computing device.

12. The system of claim 11, comprising the data processing system configured to:
replace, responsive to the scroll-over actuation of the preview interface, at least part of the preview interface with a placeholder icon displayed in the content item slot of the information resource; and
provide, based on the scroll-over actuation of the preview interface, in place of the placeholder icon, the content item for display in the content item slot of the information resource at the content provider computing device.

13. The system of claim 11, comprising the data process system configured to:
provide a script to the content provider computing device for execution, by the content provider computing device, to identify the content item slot of the information resource; and
obtain information about the content item slot of the information resource.

14. The system of claim 13, comprising the data processing system configured to:
provide the script from the data processing system to a content publisher computing device associated with the information resource, the script configured for downloading from the content publisher computing device to the content provider computing device responsive to a request by the content provider computing device to access the information resource.

15. The system of claim 11, comprising the data processing system configured to:
generate a placement campaign document for display at the content provider computing device, the placement campaign document including the rendering of the information resource at the content provider computing device.

16. (canceled)

17. The system of claim 11, comprising the data processing system configured to:
provide a script for execution at the content provider computing device to render the information resource at the content provider computing device, responsive to a request by the content provider computing device to access the information resource.

18. The system of claim 11, comprising the data processing system configured to:
provide the rendering of the information resource within a placement campaign document for display by the content provider computing device.

19. A computer readable storage device storing instructions that when executed by one or more data processors, cause the one or more data processors to perform operations comprising:
identifying a request from a content provider computing device via a computer network to initiate a direct content item placement campaign, the request indicating an information resource;
identifying, responsive to the request, a content item slot of the information resource;
providing a rendering of the information resource for display by the content provider computing device, the rendering including a preview interface indicating the identified content item slot, the preview interface overlaying over at least part of the identified content item slot;
detecting a scroll-over actuation of the preview interface overlaid on the identified content item slot during display of the information resource at the content provider computing device;
replacing, responsive to the scroll-over actuation of the preview interface, at least part of the preview interface with a placeholder icon displayed in the identified content item slot of the information resource;
identifying, responsive to at least one of the request and the scroll-over actuation of the preview interface, a content item associated with the content provider computing device; and
providing, based on the scroll-over actuation of the preview interface, in place of the placeholder icon, the content item for display in the identified content item slot of the information resource at the content provider computing device.

20. The computer readable storage device of claim 19, the computer readable storage device storing instructions that when executed by one or more data processors, cause the one or more data processors to perform operations comprising:
identifying a request from the content provider computing device to the content publisher computing device via the computer network to access the information resource;
detecting actuation of a solicitation interface at the content provider computing device; and
identifying the request to initiate the direct content item placement campaign based on the actuation of the solicitation interface.

21. The computer readable storage device of claim 19, the computer readable storage device storing instructions that when executed by one or more data processors, cause the one or more data processors to:
provide a script for execution at the content provider computing device to provide the rendering of the information resource at the content provider computing device.

22. The computer readable storage device of claim 19, the computer readable storage device storing instructions that when executed by one or more data processors, cause the one or more data processors to:
generate a placement campaign document for display at the content provider computing device; and
provide the rendering of the information resource within the placement campaign document.
